(19) United States
(12) Patent Application Publication
(10) Pub. No.: US 2009/0065682 A1
(43) Pub. Date: Mar. 12, 2009

(54) SOI structure including nanotaper with improved alignment capabilities to external light guide

(75) Inventor: Mark Webster, Bethlehem, PA (US)

Correspondence Address: Wendy W. Koba, Esq., PO Box 556, Springtown, PA, 18081, US

(73) Assignee: Lightwire, Inc.

(21) Appl. No.: 12/228,619

(22) Filed: Aug. 13, 2008

Related U.S. Application Data
(60) Provisional application No. 60/964,721, filed on Aug. 14, 2007.

(51) Int. Cl. G01J 1/42; G02B 6/26

(52) U.S. Cl. 250/208.2; 385/43

(57) ABSTRACT

An arrangement for providing alignment between an optical nanotaper coupler and a free space optical signal includes the formation of a “ridge” structure around the location of the nanotaper coupler to reduce stray light-related errors in the alignment process. The ridge is preferably formed by etching vertical sidewalls through the inter-level dielectric (ILD) and buried oxide (BOX) layers of the SOI structure. When an optical source (such as an illuminated fiber, laser, etc.) is scanned across this etched arrangement, the signal received by an associated photodetector registers an increase at the boundary between the etched region and the vertical sidewall of the ridge, thus defining the bounds within which the nanotaper coupler is located. Since the dimensions of the ridge are known and controlled by the etching process, the location of the nanotaper coupler tip along the endface of the ridge can be determined from this scan.

### CROSS-REFERENCE TO RELATED APPLICATION

This application claims the benefit of U.S. Provisional Application No. 60/964,721, filed Aug. 14, 2007.

### TECHNICAL FIELD

The present invention relates to a silicon-on-insulator (SOI)-based nanotaper alignment arrangement and, more particularly, to forming an alignment ridge around the location of a nanotaper to create physical demarcations defining the nanotaper location.

### BACKGROUND OF THE INVENTION

SOI-based lightwave systems are generally based on a structure including a silicon substrate, buried oxide layer (often referred to as the “BOX layer”) and a relatively thin silicon waveguiding layer (referred to as the “SOI layer”). Over the SOI layer, an inter-level dielectric layer (ILD layer) is formed.

One of the most promising types of optical coupling into/out of “thin” optical waveguides formed within the surface layer of a silicon-on-insulator (SOI) structure has been defined as a “nanotaper”. A nanotaper is generally defined as a terminating portion of a core of a high index contrast waveguide that is used to effectuate optical coupling between a fiber (or other type of optical transmitting device, such as a laser, laser/lens combination, or the like) and a thin waveguide. In a typical device construction, the lateral dimension of the portion of the nanotaper proximate to the core of the waveguide approximately matches the width of the core. The lateral dimension of the nanotaper decreases monotonically along the direction of light propagation until it reaches a small value associated with a “tip” (i.e., that portion of the nanotaper distal from the core of the waveguide). The tip portion represents the point at which light first enters the high index contrast waveguide for an “entry” nanotaper, or the point at which light first exits the high index contrast waveguide for an “exit” nanotaper.

In most arrangements, the device is cleaved such that the tip of the nanotaper generally coincides with a cleaved edge of the optical waveguide structure. Light is then launched directly into the tip of an entry nanotaper (or extracted directly from the tip of an exit nanotaper). The mode size at the nanotaper tip is relatively large (due to the weak confinement of the light) and shrinks as the nanotaper expands in size, providing tighter confinement of the light as the effective index increases along the length of the nanotaper. This effect facilitates the required mode conversion into the smaller mode associated with the waveguide structure.

While various nanotaper couplers have been relatively successful in coupling a lightwave signal from an optical fiber into an optical waveguide (and vice versa), there are limitations in how they are employed. In particular, the ability to align an optical fiber with such a small-dimensioned coupling arrangement has proven to be problematic. For the most part, “active” alignment techniques have been employed, where an optical signal is passed through an optical fiber and into the tip of the nanotaper coupler. A photodetecting device mounted on/included in the optical structure is then used to measure the in-coupled optical signal power between the free space signal and the nanotaper. The optical coupling efficiency (measured as a function of the optical power received at the photodetecting device) is used as a calibration signal, where the position of the fiber endface with respect to the tip of the nanotaper is manipulated until maximum coupling efficiency is achieved.

One remaining problem with this alignment arrangement, however, is that stray light coupling into the material surrounding the nanotaper coupler will also couple into the photodetector, thus creating a “noise” factor which limits the accuracy of the alignment process.

### SUMMARY OF THE INVENTION

The need remaining in the prior art is addressed by the present invention, which relates to a silicon-on-insulator (SOI)-based nanotaper coupling arrangement and, more particularly, to forming a “ridge” ILD/BOX structure around the location of the nanotaper coupler to reduce stray light-related errors in the alignment process.

In accordance with the present invention, conventional CMOS processing techniques are used to pattern and etch away portions of the arrangement's ILD and BOX layers to create a rib-like ridge structure surrounding the nanotaper coupler. When an optical source (such as an illuminated fiber, laser or the like) is scanned across this etched arrangement, the signal received by an associated photodetector registers an increase at the boundary between the etched region and the vertical sidewall of the ridge, thus defining the bounds within which the nanotaper coupler is located. Since the dimensions of the ridge are known and controlled by the etching process, the location of the nanotaper coupler tip along the endface of the ridge can be determined from this scan. Other, active alignment arrangements may then be used, if necessary, to “fine-tune” the exact alignment between the fiber (incoming signal) and the nanotaper coupler tip.

It is an aspect of the present invention that the use of well-known and precise CMOS processing steps (patterning, etching, etc.) can be used to define the width and depth of the ridge with sufficiency accuracy. The depth of the ridge is defined along the axial direction in the SOI structure and is determined, at least in part, on the amount of stray light which needs to be captured by the photodetecting system being used to determine the transition from the etched region into the ridge structure.

In another embodiment of the present invention, a portion of the substrate material exposed by the etching process is also removed (using a deep RIE process, for example) to enlarge the cavity regions on either side of the alignment ridge and improve the accuracy of the alignment.

It is another aspect of the present invention that the alignment ridge may be used with a plurality of nanotaper couplers disposed along a substrate, with a single ridge formed to cover one or more of the nanotaper couplers. Inasmuch as the intra-nanotaper spacing is defined during fabrication, the determination of the ridge sidewall locations is sufficient to provide alignment to each of the separate nanotaper couplers, even if the ridge is formed to cover only one or a few of the nanotaper couplers.

Other and further embodiments and advantages of the present invention will become apparent during the course of the following discussion and by reference to the accompanying drawings.

### BRIEF DESCRIPTION OF DRAWINGS

Referring now to the drawings, where like numerals represent like parts in several views:

FIG. 1 contains an isometric view of a prior art, conventional SOI-based nanotaper coupler;

FIG. 2 is an isometric view of a nanotaper coupler of the present invention, with surrounding ILD and BOX layers removed to create a “ridge” over the nanotaper coupler to facilitate the alignment process;

FIG. 3 is an alternative isometric view of the arrangement of FIG. 2, clearly illustrating the regions removed to create the alignment ridge;

FIG. 4 is a top view of the arrangement of FIG. 3, indicating with an arrow the direction of an optical scan used to perform alignment;

FIG. 5 is a graph of the optical response captured by a photodetecting device during the scan operation as shown in FIG. 4;

FIG. 6 is an isometric view of an alternative embodiment of the present invention, using a remotely-located photodetecting device to assist in the alignment process;

FIG. 7 is a top view of the embodiment of FIG. 6;

FIG. 8 is an isometric view of yet another embodiment of the present invention, in this case associated with providing alignment to a plurality of nanotaper couplers disposed as a linear array;

FIG. 9 is a top view of the embodiment of FIG. 8;

FIG. 10 a graph of the optical response captured by a photodetecting device during the scan operation as shown in FIG. 9;

FIG. 11 is an isometric view of another embodiment of the present invention, including an optical tap in association with the nanotaper coupler for directing a portion of the signal passing through the nanotaper coupler into a photodetecting device and providing additional location information for “fine-tuning” the alignment to the nanotaper tip;

FIG. 12 is a cut-away side view of the embodiment of FIG. 11;

FIG. 13 is a top view of the embodiment of FIG. 11;

FIG. 14 is a graph of the optical response from a photodetecting device associated with the embodiment of FIG. 11;

FIG. 15 is a side view of another embodiment of the present invention, in this case with a portion of the underlying substrate removed to reduce the amount of “noise” in the detected optical signal; and

FIG. 16 is an isometric view of the embodiment of FIG. 15.

### DETAILED DESCRIPTION

For the sake of comparison, FIG. 1 contains an isometric view of a prior art, conventional SOI-based nanotaper coupler. This arrangement is also referred to in the art as an “inverse nanotaper”, inasmuch as the narrowest portion of the taper (the “tip”) is used as the coupling endface of the arrangement. Referring to FIG. 1, a silicon-on-insulator (SOI) structure 1 is defined as comprising a silicon substrate 2, a buried oxide (BOX) layer 3 and a relatively thin silicon surface layer (SOI layer) 4. In the arrangement as shown in FIG. 1, SOI layer 4 has been etched (or otherwise processed) to form a nanotaper coupler 5, which thereafter terminates into a waveguiding region 6. In the illustration of FIG. 1, a corner portion of SOI layer 4 is illustrated in phantom to show its position relative to the other layers in the structure. A relatively thick inter-level dielectric (ILD) layer 7 is disposed over nanotaper coupler 5 and waveguiding region 6 (as well as any other components which may be formed in SOI layer 4).

As mentioned above, one problem with the use of nanotaper coupler 5 is providing alignment between tip 8 of coupler 5 and an incoming optical signal (“IN”) such as from an optical fiber or other free space source (not shown). In most cases, an “active” alignment system is used, where a photodetecting device is disposed in the vicinity of the nanotaper coupler and monitors the power level of the incoming signal. An optical tap is generally used to remove a portion of the signal propagating along waveguiding region 6, re-directing this portion into the photodetector, which then defines “alignment” to be achieved when a maximum power level is recorded. Providing the alignment between an optical source with a suitable mode field diameter into the nanotaper coupler and a nanotaper tip (with a core diameter on the order of, for example, 100-300 nm) has been found to be difficult to achieve efficiently and in a cost-effective manner with conventional, prior art active alignment systems.

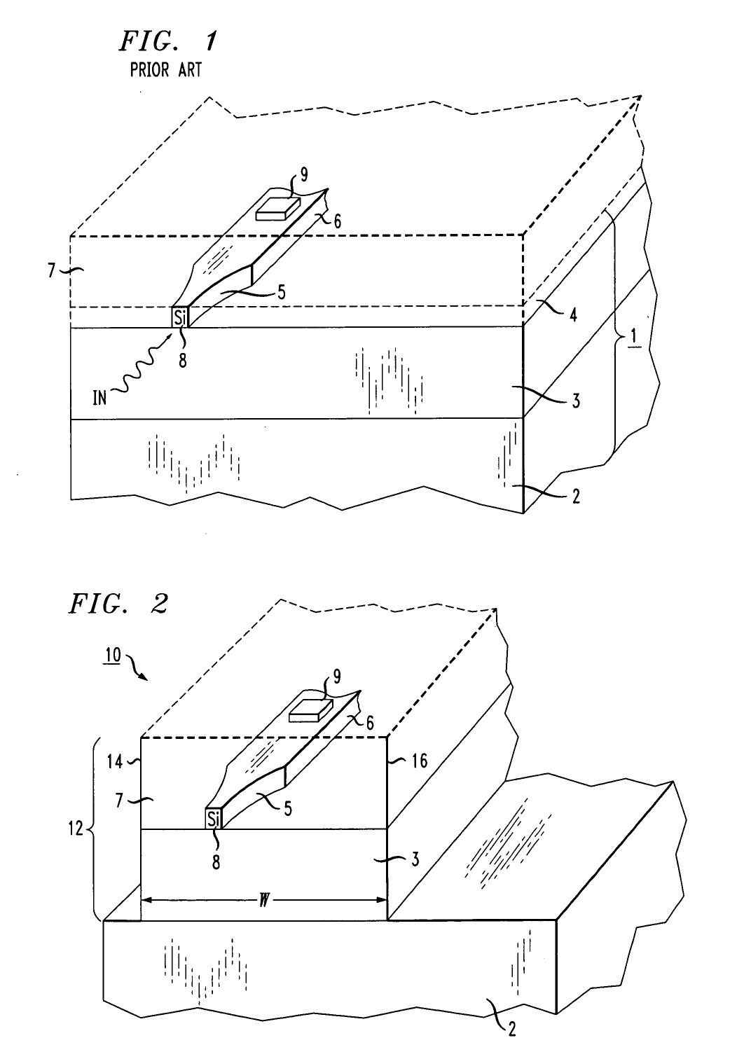

FIG. 2 is an isometric view of an exemplary nanotaper coupling arrangement 10 formed in accordance with the present invention. It is to be noted that the various SOI layers described above in association with the prior art arrangement carry the same reference numerals in FIG. 2 (as well as the remaining figures), for the sake of clarity. As will be discussed in detail hereinbelow, a predetermined portion of BOX layer 3 and ILD layer 7 on either side of nanotaper coupler 5 are removed to form a “ridge” area 12 surrounding nanotaper coupler 5 (and may be deep enough to also cover a portion of waveguiding region 6). As shown, ridge 12 is defined as including vertical sidewalls 14 and 16, separated by a predetermined width W, with nanotaper coupler 5 disposed within ridge 12 at a known location relative to vertical sidewalls 14 and 16. A photodetecting device 9 is disposed within arrangement 10 along waveguide 6 (alternatively, on nanotaper coupler 5, an exposed surface region of ILD layer 7, or the like) and is used to monitor the presence of stray light within ridge 12. “Photodetecting device” is to be considered broadly in this application as defining a PN or PIN photodiode, any other type of photosensitive device, camera, vision system or any suitable “device” responsive to an optical input signal. For the sake of simplicity, the use of the phrase “photodetecting device” throughout the remainder of this specification, as well as the appended claims, is considered to encompass all of these variations, as well as any equivalent thereof.

In accordance with the present invention, therefore, as an illuminated fiber (or other light source) is horizontally scanned across the endface of arrangement 10 during alignment, photodetecting device 9 will begin to receive a signal as soon as the scan crosses the boundary of vertical sidewall 14 (or sidewall 16, depending on the scan direction) into ridge 12. By being able to determine the locations of sidewalls 14 and 16 using this signal, and knowing the position of nanotaper coupler 5 within ridge 12, the incoming light source can be quickly and more easily aligned with nanotaper coupler tip 8 than possible with the prior art methods.

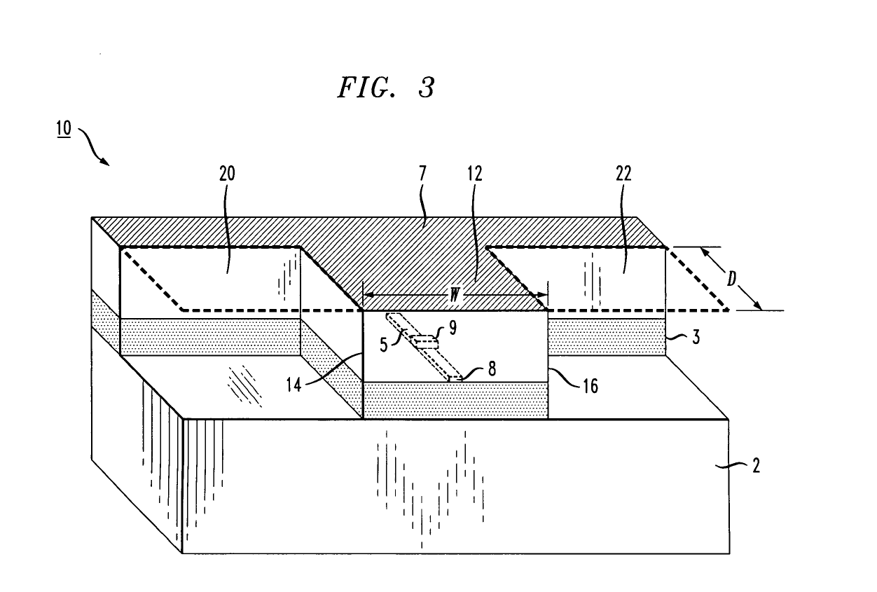

FIG. 3 is another isometric view of arrangement 10 of FIG. 2, in this case using dotted lines to indicate cavity regions 20 and 22 where portions of ILD layer 7 and BOX layer 3 have been removed. Also evident in this view is the depth D of cavity regions 20 and 22, the depth measured from the endface of arrangement 10. The depth is determined, at least in part, on the amount of stray light which needs to reach photodetecting device 9 to create the desired optical response (as shown below in FIG. 5, for example) and the specific location of photodetecting device 9 (e.g., on ridge structure 12, on the rear portion of ILD layer 7, etc.). In one exemplary embodiment, the width W of ridge 12 may be on the order of 6-10 μm, with the depth D being approximately 100 μm. Obviously, the choices for these dimensions are at the discretion of the designer. Advantageously, straightforward and well-known CMOS processing techniques may be used to pattern and etch the structure to form cavity regions 20 and 22, providing the desired accuracy in both the depth and width of the etch. Moreover, it is to be understood that cavity regions 20 and 22 may comprise different widths, and need not be uniform, since nanotaper coupler 5 may be disposed at virtually any location along the endface of arrangement 10. The presence of silicon substrate 2 underneath BOX layer 3 will function as an “etch stop” to prevent all of the material from being removed. It is also contemplated that cavity regions 20 and 22 formed by the removal of portions of ILD layer 7 and BOX layer 3 may be “re-filled” with a light-absorbing material (such as, for example, a light absorbing polymer) to further aid in defining the boundary between regions 20, 22 and ridge 12. The remainder of this discussion will thus simply refer to “regions 20, 22”, with the understanding that the regions may remain as “cavity” regions or, alternatively, be re-filled with another material having light absorbing qualities.

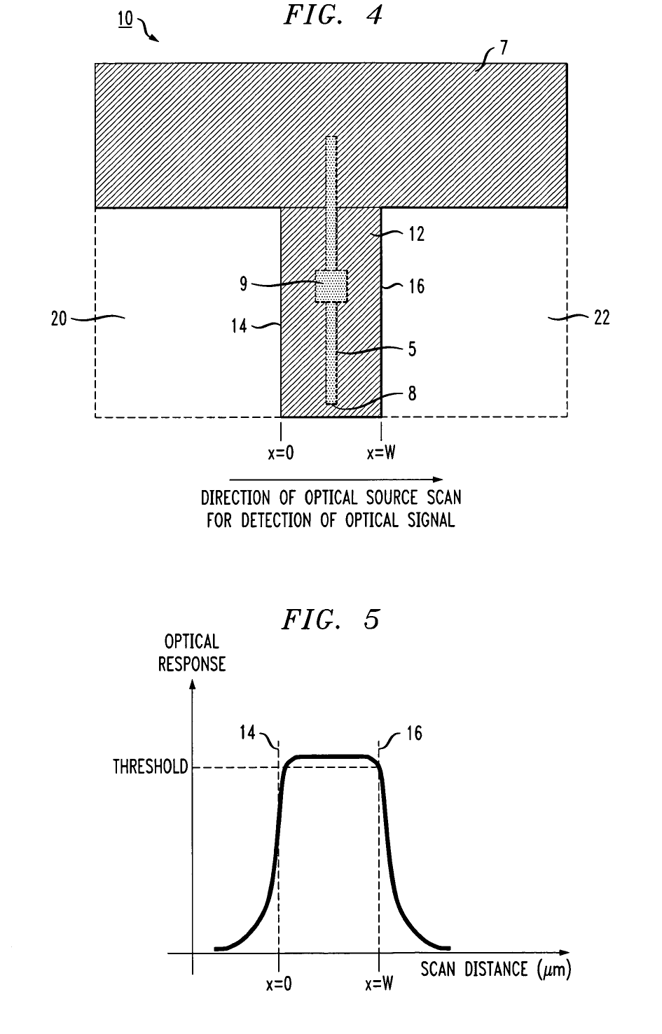

FIG. 4 is a top view of the arrangement of FIG. 3, useful in understanding the details of obtaining alignment between a free space optical signal and tip 8 of nanotaper coupler 5. In accordance with the present invention, a free space light source (such as an illuminated fiber, laser, lensed lasing arrangement or the like (not shown)) is scanned in a horizontal direction across the endface of arrangement 10. FIG. 5 is a graph depicting the signal received by photodetecting device 9 as the scan proceeds. For the purposes of the present invention, a “horizontal” scan is defined as being taken along a direction perpendicular to “vertical” sidewalls 14 and 16.

In an exemplary arrangement, the scan may move from left to right, as shown by the arrow in FIG. 4. Obviously, it is equally possible to scan from right to left and accomplish the same results. Referring to FIG. 4, as the scan moves across region 20 and intersects sidewall 14 of ridge 12, an increase in the light reaching photodetecting device 9 is observed, since the illumination is moving from the cavity area (region 20) into a light propagating area (ridge 12). This transition is defined as location “x=0” in the graph of FIG. 5, which clearly illustrates the increase in received optical power. Thereafter, as the scan moves from ridge 12 into cavity region 22, a decrease in optical signal is observed. The point where this transition is observed is then defined as “x=W” (see FIG. 5), defining the location of sidewalls 14 and 16 for this particular ridge 12.

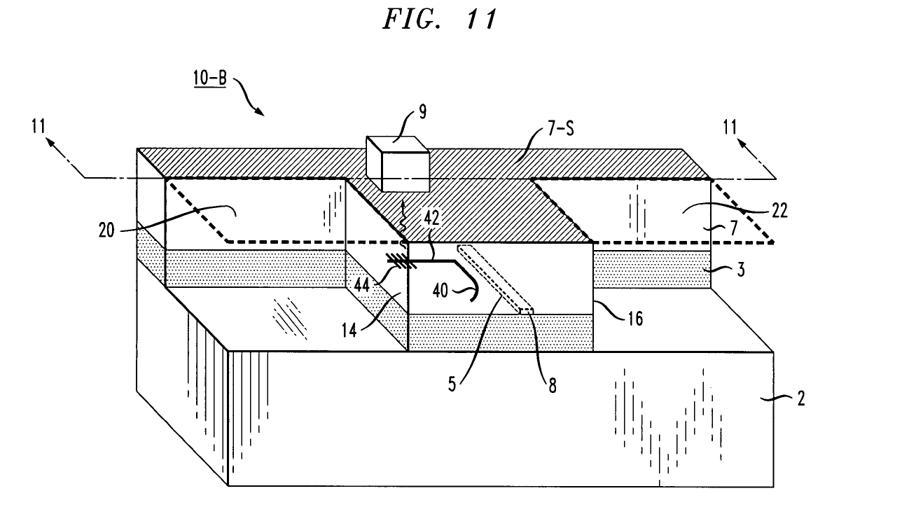

Since the width W of this maximized response is precisely defined during the formation of ridge 12 by conventional semiconductor processing techniques, and the scan provides the location information of sidewalls 14 and 16, the location of nanotaper coupler 5 can be determined with improved accuracy over prior art methods. Once the location of nanotaper coupler 5 within ridge 12 is defined, a “fine” alignment process may then used, if necessary and discussed below in association with FIGS. 11-14, to maximize the coupling between the incoming signal and nanotaper tip 8.

In the particular embodiment shown in FIGS. 3 and 4, photodetecting device 9 may comprise an integrated photodiode which directly disposed on nanotaper coupler 5, or further back on a portion of waveguiding region 6. An exemplary arrangement for forming and using a photodetector directly disposed on a nanotaper coupler may be found in co-pending U.S. application Ser. No. 11/811,799, assigned to the assignee of this application and herein incorporated by reference. Alternatively, photodetecting device 9 may be disposed on the surface of BOX layer 3 or ILD layer 7, at a location removed from the position of nanotaper coupler 5/waveguiding region 6.

Inasmuch as ridge 12 essentially functions as a waveguide during the scan, the required sensitivity of photodetecting device 9 need only be sufficient to recognize the transition from relatively little or no signal (in regions 20 and 22) to the presence of stray light within ridge 12. Remember that the term “photodetecting device”, as used in this discussion, is considered to include a conventional, integrated or discrete photodiode, a camera arrangement, vision system or any other suitable light sensing element capable of provide an optical response curve as shown in FIG. 5. Thus, it may be preferred to utilize a photodetecting device mounted on a surface of ILD layer 7 (on either, for example ridge structure 12 or the rear portion of ILD layer 7), where the use of a surface-mounted arrangement is easier to implement than incorporating another processing step in the nanotaper fabrication process.

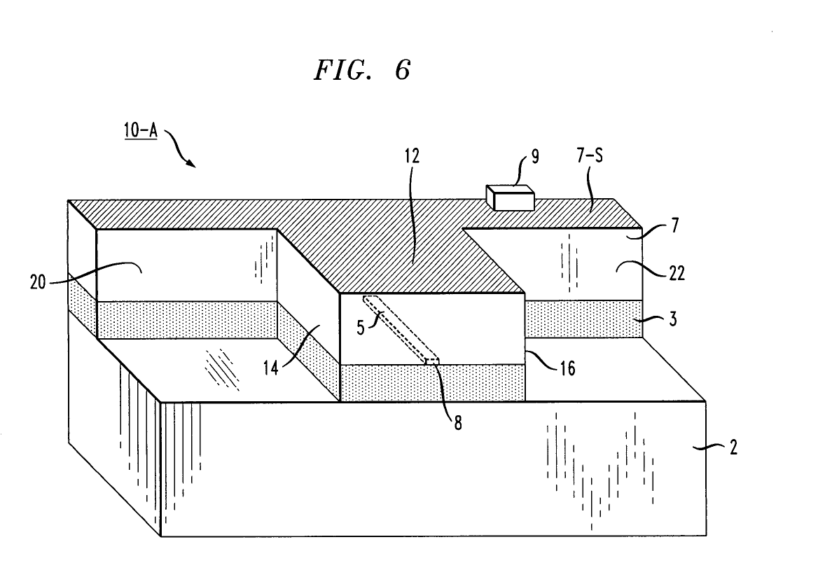

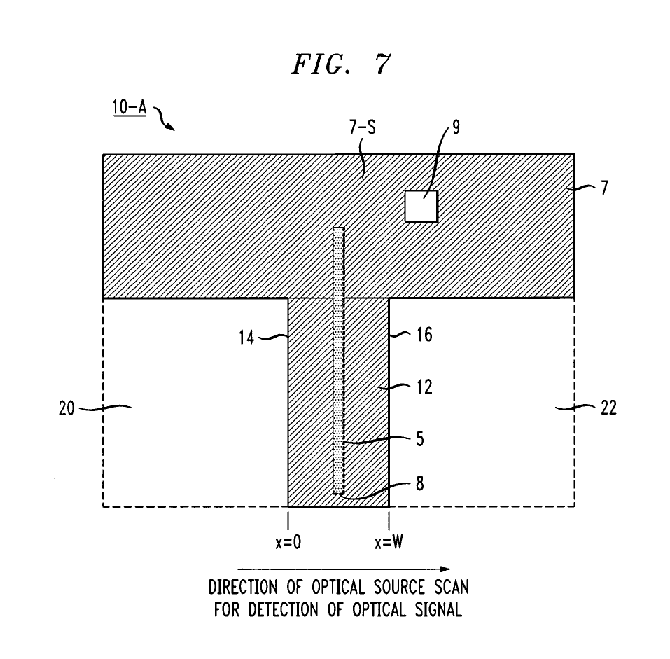

FIG. 6 is an isometric view of an alternative embodiment 10-A, in this case with photodetecting device 9 disposed on a rear portion of top surface 7-S of ILD layer 7. FIG. 7 is a top view of this same embodiment. For the purposes of the present invention, the stray light captured by remotely-located photodetecting device 9 as it propagates through ridge 12 is sufficient to perform the alignment activities. As with the arrangement discussed above in association with FIGS. 3 and 4, a light source is horizontally scanned across arrangement 10-A of FIG. 6. As the incoming light transitions from region 20 through sidewall 14 and into ridge 12, the stray light propagating through ridge 12 (even before encountering nanotaper coupler 5) will be sufficient to be measured by photodetecting device 9. Similarly, as the scan moves out of ridge 12 and into region 22, the stray light reaching photodetecting device 9 will disappear and the response from photodetecting device 9 will drop off. Indeed, the optical response curve associated with arrangement 10-A will be similar to that shown in FIG. 5. Thus, the location of sidewalls 14 and 16 can be determined by using a remotely located photodetecting device.

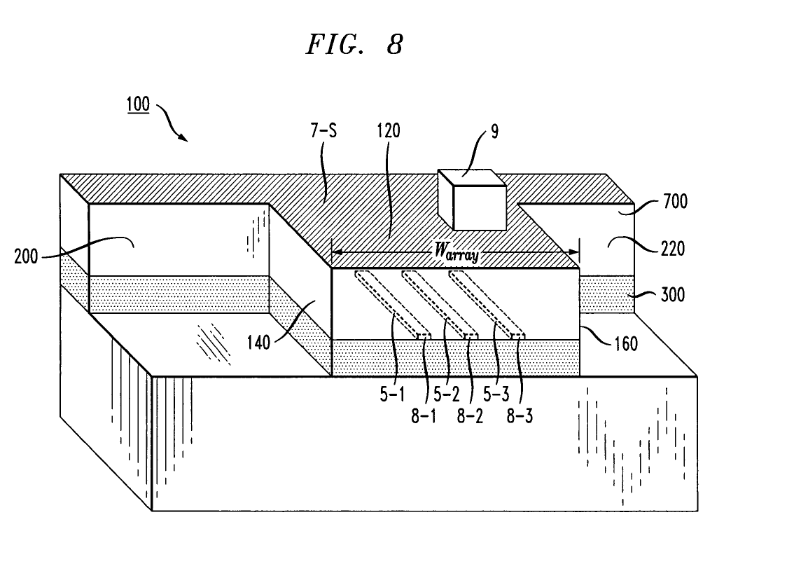

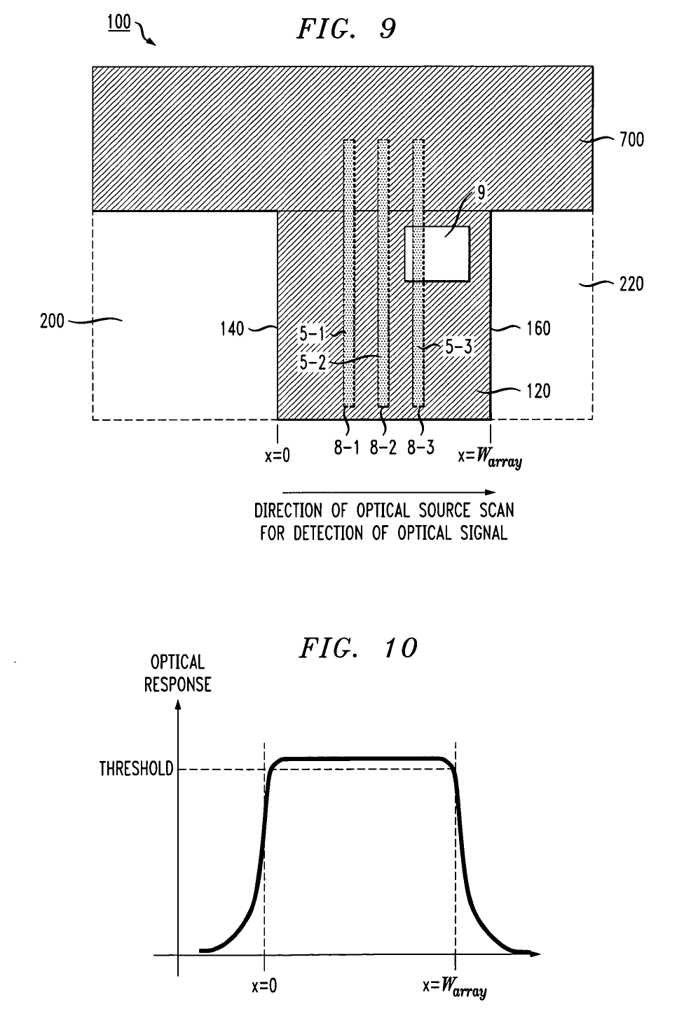

While the embodiments described thus far have illustrated the ability to align an incoming signal source to a single nanotaper, it is to be understood that the principles of the present invention are equally applicable to an array arrangement, with a multiple number of nanotapers needing to be aligned with a respective number of light sources. FIGS. 8 and 9 illustrate this embodiment of the present invention, where FIG. 8 is an isometric view and FIG. 9 is a top view useful in understanding the alignment process itself.

Referring to FIG. 8, a plurality of three separate nanotaper couplers 5-1, 5-2 and 5-3 are shown as disposed within an arrangement 100. The set of “three” is considered to be exemplary only, for the purposes of describing the array embodiment of the present invention. Of course, a similar alignment process may be used with virtually any number of nanotaper couplers. Arrangement 100 has been patterned and etched, as described above, to remove portions of BOX layer 300 and ILD layer 700, leaving a ridge 120 which covers (in this embodiment) the entire group of nanotapers 5-1, 5-2 and 5-3. Referring to FIG. 8, the width of ridge 120 is defined as W_{array}. Ridge 120 is defined as including sidewalls 140 and 160, which are used by the scanning process to determine the boundaries of ridge 120 with respect to removed regions 200 and 220.

Inasmuch as the separation between adjacent nanotaper couplers 5 is determined by a lithographic process during device formation, there is no need to perform multiple alignments to each nanotaper tip 8-1, 8-2 and 8-3. That is, once the location of sidewalls 140 and 160 is made by the optical detection system, that information coupled with the intra-nanotaper separation will allow for the simultaneous alignment of each nanotaper tip to its associated light source. Therefore, only a single photodetecting device 9 is required (shown in this particular embodiment as being disposed on surface 7-S of ILD layer 700), since the detection process needs only to “find” the location of vertical sidewalls 140 and 160. Moreover, the known spacing and location of the plurality of nanotaper couplers 5-1, 5-2 and 5-3 allows for ridge 120 to alternatively be formed to cover only one (or two) of the nanotaper couplers (and, possibly associated waveguide), since as long as the position of one nanotaper coupler is determined from sidewalls 140 and 160, the location of the remaining nanotaper couplers in the array will be defined as well.

It is to be understood that the arrangement of FIG. 8 is exemplary only and, in general, any non-uniform spacing may be used between adjacent nanotaper couplers. The nanotaper tips may themselves be inset so as to be located back from the endface of arrangement 100 by a predetermined amount. Moreover, while the embodiment of FIG. 8 illustrates the use of a one dimensional, linear array, it is contemplated that the alignment process of the present invention may also be used with a stacking, two-dimensional array arrangement, as disclosed and discussed in our co-pending application U.S. Ser. No. 12/218,367, filed Jul. 15, 2008. All of these variations are possible to use with the alignment system of the present invention, since the nanotapers are lithographically defined during fabrication, allowing for their precise locations with respect to the vertical sidewalls of the alignment ridge to be precisely known.

FIG. 9 is a top view of array arrangement 100, and FIG. 10 is an exemplary graph of the optical response from photodetecting device 9. Again, the detection process is used only to “find” the location of sidewalls 140 and 160 of ridge 120, as indicated by the obvious transitions in signal response at photodetecting device 9 (see FIG. 10). With this information, and the a priori information with respect to the spacing between adjacent nanotaper couplers 5, alignment between a plurality of sources and a plurality of nanotapers can be achieved. Again, this information allows for ridge 120 to be formed to cover only one, or any selected number of nanotaper couplers, instead of covering the entire array.

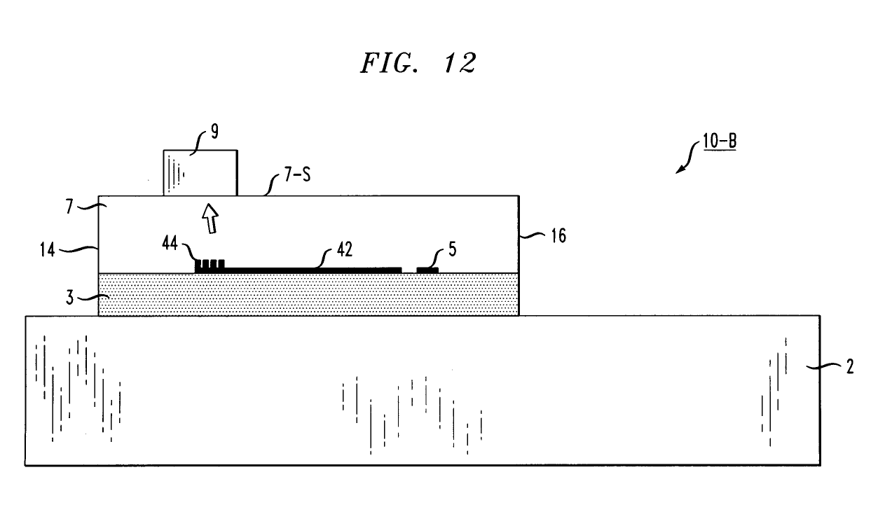

FIG. 11 is an isometric view of an alternative arrangement 10-B of the present invention which is further capable of providing location information associated with the exact location of nanotaper coupler 5 within ridge 12. As mentioned above, while the alignment process of the present invention is more than sufficient to define the location of the alignment ridge sidewalls with respect to the remainder of the optical substrate endface, an additional amount of “fine-tuning” may be used to precisely locate nanotaper tip 8 within ridge 12. In this arrangement, a directional coupler 40 and waveguide 42 are formed adjacent to nanotaper coupler 5 (or alternatively, to waveguiding region 6) so as to out-couple a portion of the optical signal propagating therealong. Photodetecting device 9 is disposed, in this case, on top surface 7-S of ILD layer 7, where a grating 44 is formed at the termination of waveguide 42 and used to re-direct the optical signal upward into photodetecting device 9. FIG. 12 is a cut-away side view of a portion of the embodiment of FIG. 11, illustrating the direction of light propagation into photodetecting device 9. While in this illustrated embodiment the same photodetecting device 9 is used for both the vertical sidewall recognition location and the fine-tuning process, it is equally possible that two different photodetecting devices (with different sensitivities, if necessary) may be used to perform these separate functions.

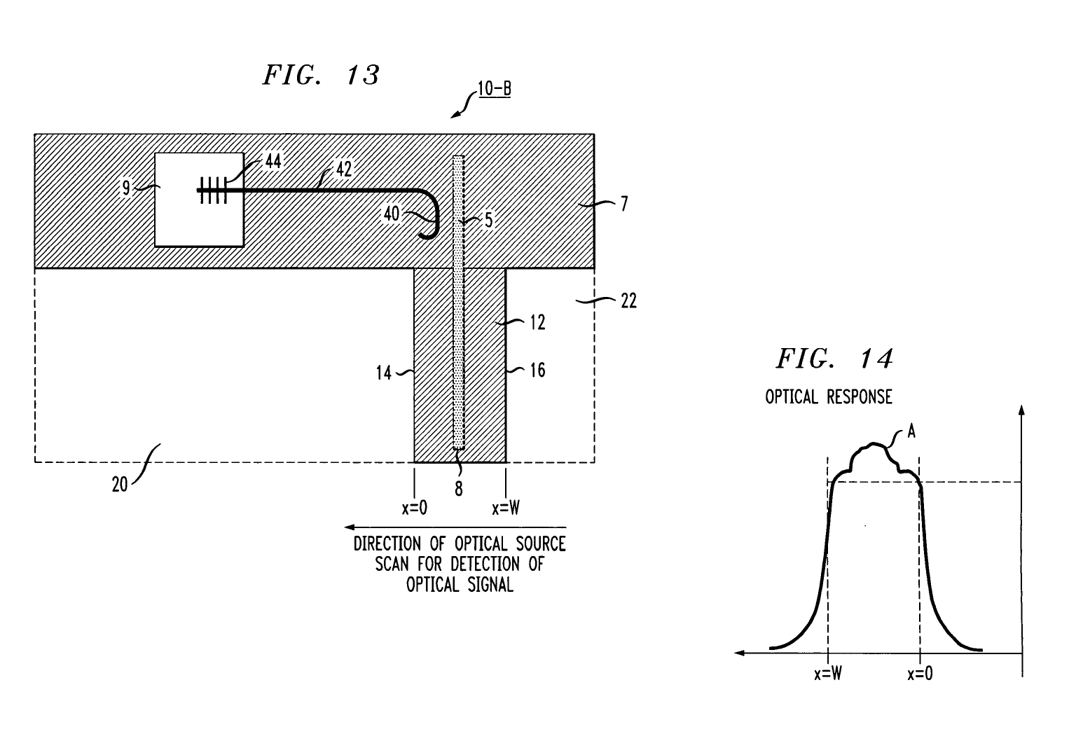

In practice, an optical scan as discussed above is directed across the endface of arrangement of arrangement 10-B. FIG. 13 is a top view of this particular embodiment, which clearly illustrates the placement of directional coupler 40, waveguide 42 and grating 44. Thus, as a light source is scanned across the endface of arrangement 10-B (in this case, the scan is shown as moving from right to left), a first threshold response is received when the source transitions across sidewall 16 from region 22 into ridge 12. As the scan reaches nanotaper coupler 5, the presence of directional coupler 40 and waveguide 42 will cause a significant increase in photodetection response (as compared to the stray light response associated with ridge 12).

FIG. 14 includes a graph depicting the response that may be measured by photodetecting device 9 as used in arrangement 10-B. The increase in response, associated with receiving a portion of the signal directly coupled into nanotaper coupler 5, is shown by section A in the graph. As the scan moves away from the location of nanotaper coupler 5 (yet is still within ridge 12), the optical response returns to the value associated with the capture of stray light by photodetecting device 9. When the scan signal transitions out of ridge 12, across sidewall 14 and into cavity region 20, the optical response drops off dramatically. In this case, the alignment arrangement is able to define the locations of sidewalls 14 and 16, as well as provide an indication of the location of nanotaper coupler 5 within ridge 12.

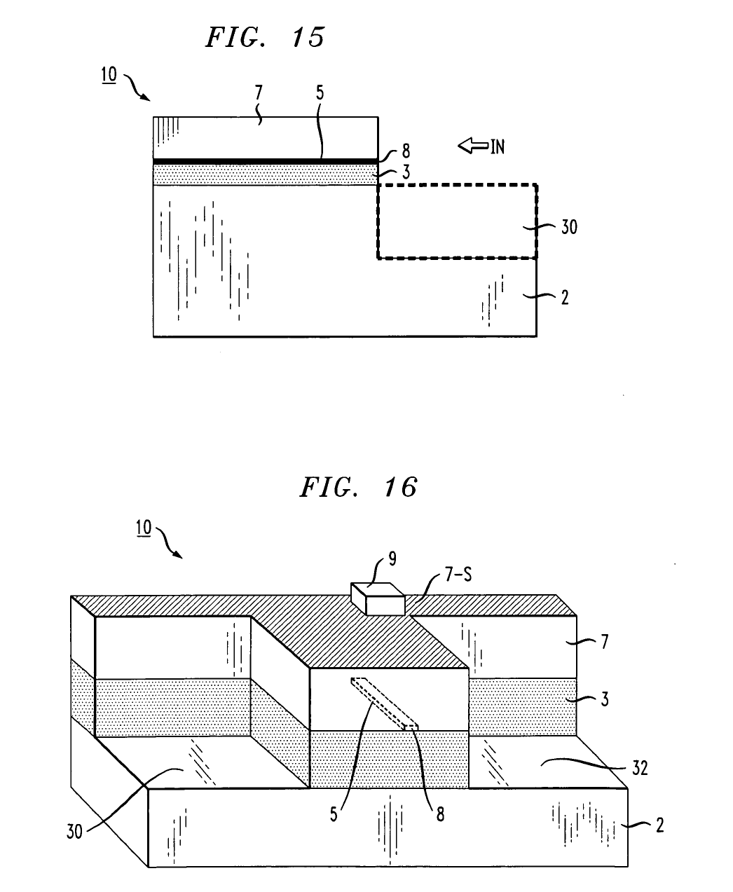

FIG. 15 is a side view of an alternative embodiment of the present invention, in this case where a portion of the exposed areas of silicon substrate 2 is removed. FIG. 16 is an isometric view of this embodiment. This removal may be accomplished, for example, by using a deep reactive ion etching (DRIE) technique. The creation of the deeper regions 30 and 32 on either side of ridge 12 creates more definite regions of signal isolation on either side of ridge 12, since a larger (deeper) isolation region can be created on either side of ridge 12. As a result, a sharper transition will be registered at sidewalls 14 and 16, allowing for a less sensitive photodetecting device to be used while achieving virtually the same alignment accuracy.

The removal of a portion of silicon substrate 2 is considered to be an alternative implementation of the method of the present invention, and is fully captured within the spirit and scope of the present invention as particularly defined by the claims appended hereto.

What is claimed is:

1. An arrangement for providing optical alignment between at least one nanotaper coupler disposed within an optical structure and a free space optical signal where a terminating tip of the at least one nanotaper coupler is exposed along an endface of the optical structure, the arrangement comprising
a ridge structure formed in the optical structure and comprising spaced-apart vertical sidewalls separated by a predetermined width, the ridge disposed to surround the at least one nanotaper;
cavity regions disposed on either side of the ridge structure so as to be adjacent to the spaced-apart vertical sidewalls; and
a photodetecting device for measuring an optical signal propagating within the ridge structure such that as an external optical signal is horizontally scanned across the optical structure, the difference in response between the cavity regions and the ridge structure defines the location of the ridge and associated nanotaper coupler tip for providing alignment thereto.

2. An arrangement as defined in claim 1 wherein the cavity regions are thereafter refilled with a light-absorbing material.

3. An arrangement as defined in claim 2 wherein the light-absorbing material comprises a light-absorbing polymer material.

4. An arrangement as defined in claim 1 wherein the optical structure comprises a silicon-on-insulator (SOI) structure comprising a silicon substrate, a buried oxide (BOX) layer, an upper silicon layer (SOI layer) with the at least one nanotaper coupler formed within the SOI layer, and an overlying interlevel dielectric (ILD) layer, wherein the ridge structure is formed by removing portions of the ILD layer and BOX layer on either side of at least one nanotaper coupler in a manner which forms the spaced-apart vertical sidewalls of the ridge structure.

5. The arrangement as defined in claim 4 wherein the ILD and BOX layers are patterned and etched to remove defined portions sufficient to form the defined ridge structure.

6. The arrangement as defined in claim 4 wherein a portion of the silicon substrate is removed in the formation of the ridge structure vertical sidewalls.

7. The arrangement as defined in claim 6 wherein a deep RIE process is used to remove a portion of the silicon substrate.

8. The arrangement as defined in claim 1 wherein the at least one nanotaper coupler comprises a single nanotaper coupler.

9. The arrangement as defined in claim 1 wherein the at least one nanotaper coupler comprises a plurality of nanotaper couplers.

10. The arrangement as defined in claim 9 wherein the ridge structure is formed to cover a single nanotaper coupler of the plurality of nanotaper couplers.

11. The arrangement as defined in claim 9 wherein the ridge structure is formed to cover more than one nanotaper coupler of the plurality of nanotaper couplers.

12. The arrangement as defined in claim 9 wherein the ridge structure is formed to cover the plurality of nanotaper couplers.

13. The arrangement as defined in claim 9 wherein the plurality of nanotaper couplers is disposed as a one-dimensional linear array.

14. The arrangement as defined in claim 9 wherein the plurality of nanotaper couplers is disposed as a plurality of stacked one-dimensional linear arrays, forming a two-dimensional array of nanotaper couplers.

15. The arrangement as defined in claim 1 wherein at least one nanotaper coupler tip is positioned as recessed from the endface of the optical structure.

16. The arrangement as defined in claim 1 wherein the photodetecting device is disposed along the at least one nanotaper coupler.

17. The arrangement as defined in claim 1 wherein the arrangement further comprises an optical waveguide formed in the optical structure as contiguous with the at least one nanotaper coupler and the photodetecting device is disposed along the optical waveguide.

18. The arrangement as defined in claim 1 wherein the photodetecting device is disposed at a remote location within the optical structure.

19. The arrangement as defined in claim 18 wherein the photodetecting device is disposed on an exposed surface of the optical structure.

20. The arrangement as defined in claim 1 wherein the arrangement further comprises an optical tap coupled to the at least one nanotaper coupler for directing a portion of the in-coupled signal to the photodetecting device to provide location information of the nanotaper coupler within the ridge structure.

21. The arrangement as defined in claim 1 wherein the arrangement further comprises
an optical waveguide formed in the optical structure as contiguous with the at least one nanotaper coupler; and
an optical tap coupled to the optical waveguide for directing a portion of the in-coupled signal to the photodetecting device to provide location information of the nanotaper coupler within the ridge structure.

22. The arrangement as defined in claim 21 wherein the arrangement comprises a first photodetecting device for measuring the optical signal propagating within the ridge structure and a second photodetecting device disposed to receive the signal from the optical tap.

23. A method of providing alignment between a free space optical signal and a nanotaper coupler tip disposed at, or recessed from, an endface of an optical structure, the method comprising the steps of:
a) forming a ridge along a portion of the optical substrate to surround the nanotaper coupler, the ridge formed to comprise vertical sidewalls on either side of the nanotaper coupler, separated by a predetermined distance, the vertical sidewalls defining interfaces between a cavity region in the optical structure and a light propagating region within the ridge surrounding the nanotaper coupler;
b) horizontally scanning the free space optical signal across the endface of the optical structure from a cavity region on one side of the ridge, across the ridge, and then across the cavity region on the other side of the ridge;
c) detecting a light signal within the optical structure during the scan;
d) determining the locations of the ridge vertical sidewalls by a predetermined difference in received light as the scan crosses an interface between a ridge vertical sidewall and a cavity region; and
e) based on the determined locations of the vertical sidewalls, aligning the free space optical signal to the nanotaper coupler tip.

24. The method as defined in claim 23, wherein in performing step a), the optical structure is etched to form the cavity regions on either side of the nanotaper and form a ridge structure having vertical sidewalls.

25. The method as defined in claim 23, wherein in performing step a), the method further comprises the step of filling the cavity regions with a light absorbing material.

26. The method as defined in claim 25 wherein the light absorbing material comprises a light absorbing polymer.

27. The method as defined in claim 20 wherein the optical structure comprises an SOI-based substrate including an overlying interlevel dielectric (ILD) layer and in performing step a) a surface of the ILD layer is patterned to define the ridge vertical sidewall boundaries, and the etching removes defined portions of the ILD layer and underlying buried oxide layer of the SOI-based substrate.

28. The method as defined in claim 27 wherein in performing step a), subsequent to the etching of the ILD and buried oxide layers, a second etch is performed to remove a predetermined thickness of the silicon substrate.

29. The method as defined in claim 27 wherein a deep reactive ion etch is used to remove the predetermined thickness of the silicon substrate.
